(19) United States
(12) Patent Application Publication
(10) Pub. No.: US 2010/0052287 A1
(43) Pub. Date: Mar. 4, 2010

(54) Running bike with foot rests

(76) Inventor: Ryan McFarland, Rapid City, SD (US)

Correspondence Address: Gene R. Woodle, 3516 Woodle Drive, Rapid City, SD, 57702, US

(21) Appl. No.: 12/231,248

(22) Filed: Aug. 28, 2008

(51) Int. Cl. B62J 25/00

(52) U.S. Cl. 280/291

(57) ABSTRACT

A running bike with foot rests which comprises running bike having neither pedals or other drive mechanism is disclosed. The configuration of the running bike with foot rests includes having a horizontal rear fork and a pass through seat tube which allows for a minimum seat height significantly lower than a conventional running bike. The running bike of the instant invention also includes foot rests.

### BACKGROUND OF THE INVENTION

1. Field of the Invention

The present invention relates generally to bicycles and more specifically to a running bike with foot rests which may be used by small children.

2. Background Information

People have been using bicycles for over two hundred years. Probably the first bicycle was what is often referred to as a velocipede. The velocipede looked similar to a modern bicycle in that it had a frame and two wheels, but it did not have pedals or a drive mechanism. The velocipede was powered by the operator sitting on the seat while “running” along the ground. When going down hill or after building up speed, the operator could pick up her feet and coast. It is likely that the first pedal bike had “direct drive” pedals affixed to the front axle of the bicycle. This type of bicycle had an inefficient pedal to wheel ratio and front wheels became larger and larger to create a more efficient pedal to wheel ratio. On some bicycles the front wheel was so large that there was a “step” built into the frame so that the operator could climb up onto the seat using the step. These large front wheel bicycles were dangerous and a bicycle with pedals, two drive sprockets, and a chain was invented which provided a similar pedal to wheel ratio, but with both the front and rear wheel being the same size.

Bicycles similar to the velocipede and having no pedals or other drive mechanism are regaining popularity, because they may be operated by small children who are too young to operate a pedal bicycle. These bicycles are most often referred to as “running bikes,” and are sometimes used as a substitute for tricycles. Many children who are too small to ride a conventional bicycle are capable of learning to operate a running bike with relative ease. There are several running bikes on the market. Running bikes currently available are ordinarily built using the same basic design as a conventional bicycle which doesn't allow for a seat height low enough for the average young child in the range of eighteen months to three years old. These running bikes also lack a place for a rider to safely place his feet when coasting.

The running bike with foot rests of the instant invention solves a number of problems common to running bikes: it is designed such that the seat may be configured low enough for a very small child to operate the bicycle, it has a safe place for a rider to place her feet when coasting.

The ideal running bike with foot rests should be designed such that the seat height can be low enough for a very small child. The ideal running bike with foot rests should include foot rests. The ideal running bike with foot rests should also be simple, reliable, inexpensive, and easy and safe to use.

### SUMMARY OF THE INVENTION

The running bike with foot rests of the instant invention has a configuration similar to a conventional bicycle with a frame, front and rear wheels and axles, a seat, handle bars, and a mechanism for steering the front wheel. All of these elements, except for the frame, are conventional and may be obtained from a variety of sources. The running bike with foot rests of the instant invention does not include pedals or any drive mechanism other than the operator directly applying force by pushing the feet against the ground. The operator may “run” while pushing the bike along using the handle bars. While running, most of the weight of the operator is supported by the bike seat. The operation is similar to that of a standard scooter except rather than standing on the scooter and pushing with one foot, the operator sits on the seat and pushes with both feet. When going down hill or after building up speed, the operator may coast.

The frame of the running bike with foot rests slants upward from underneath the seat to the steering tube above the front wheel. The rear “fork” is affixed to the frame beneath the seat and has the general shape of a “U” with the “U” opening rearward. The rear fork attaches the rear wheel axle to the frame and is horizontal. Because the rear fork is horizontal, a rider can use the forward portion of the rear fork as a foot rest when coasting. The horizontal rear fork design also allows the seat to be positioned very low on the frame and, thus, allows for a very low seat height. On a conventional running bike, the rear wheel is affixed to a fork or strut which angles upward at an angle significantly greater than horizontal.

The above describes the basic operating principals and configuration of the running bike with foot rests of the instant invention in one embodiment.

One of the major objectives of the present invention is to provide a design such that the seat height can be low enough for a very small child.

Another objective of the present invention is to provide a running bike with a foot rest.

Another objective of the present invention is to provide a running bike with foot rests which is simple, reliable, inexpensive, and easy to assemble, service and use.

These and other features of the invention will become apparent when taken in consideration with the following detailed description and the drawings.

### BRIEF DESCRIPTION OF THE DRAWINGS

FIG. 1 is a side view of the running bike with foot rests of the instant invention; and

FIG. 2 is a sectional view of the running bike with foot rests of the instant invention taken along line 2-2 of FIG. 1.

### DESCRIPTION OF A PREFERRED EMBODIMENT

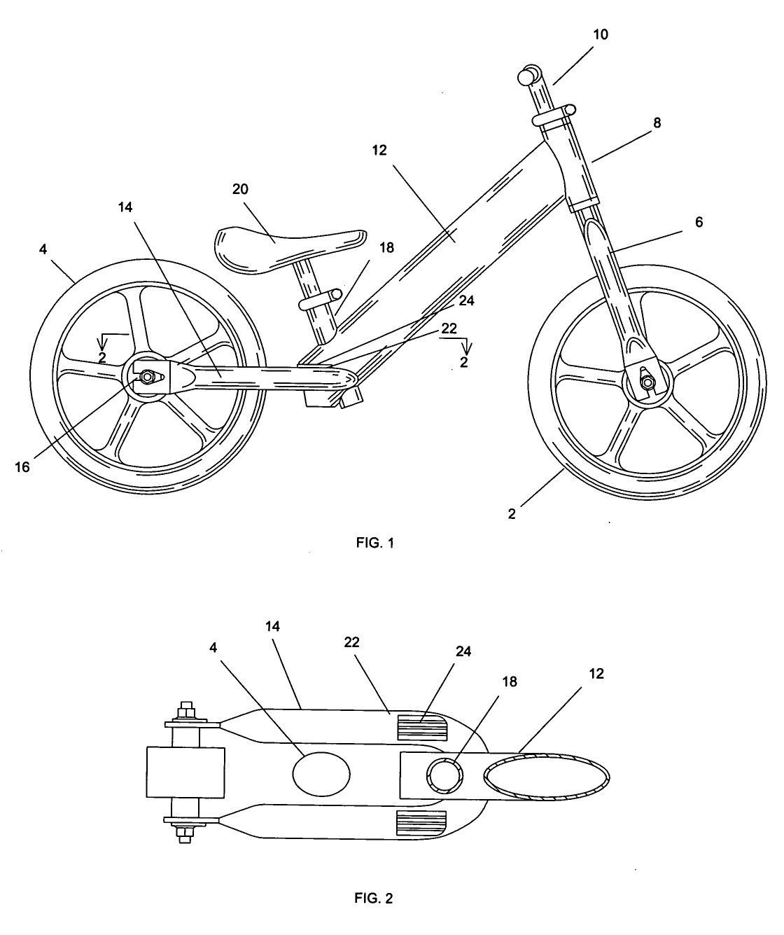

Referring to the drawings, FIGS. 1 and 2, there is shown a preferred embodiment of the running bike with foot rests of the instant invention. The instant invention is shown and described as being used as a running bike. The running bike with foot rests has a configuration similar to a conventional bicycle, but has no pedals or any other drive mechanism and is powered by the operator running while seated on the bike. Many elements of the running bike with foot rests are conventional including the front and rear wheels and axles, the handle bar and steering mechanism, and the seat. The front wheel of the running bike with foot rests of the instant invention is considered forward and the rear wheel is considered rearward.

Now referring to FIG. 1, a side view of the running bike with foot rests of the instant invention is shown. A front wheel 2 and a rear wheel 4 are provided. Several other conventional elements such as axles, nuts, bolts, bearings are well known in the field and will not be described in detail. The front wheel 2 is affixed to a front fork 6 which passes through a steering tube 8. A handle bar 10 is affixed to the front fork 6 and is a part of a conventional steering mechanism. A frame member 12 is affixed to the steering tube 8 and slants downward and rearward to a point forward of and below the center of the rear wheel 4. A rear fork 14 having the general shape of a “U” with the “U” opening rearward is affixed to the frame member 12 at its forward end just above the lowest point of said frame member 12. The rear fork 14 is horizontal and is tubular at its forward end and flattened to a plate at its rearward end. The rearward most flat portion of said rear fork 14 includes a rear fork slot 16. The axle of the rear wheel 4 fits into the rear fork slot 16 and said rear wheel 4 is affixed to the rearward end of said rear fork 14 in a conventional manner. A seat tube 18 is affixed to said frame member 12 near the rearward end of said frame member 12 and protrudes upward from said frame member 12. A conventional seat and post 20 fits within the seat tube 18 and is removably affixed to said seat tube 18 in a conventional manner.

Still referring to FIG. 1, said seat tube 18 protrudes all the way through said frame member 12. Therefore, the seatpost can protrude all the way through said frame member as well. This allows for maximum adjustment of the seat height. Said rear fork 14 also protrudes forward to a position forward of the forwardmost portions of said seat tube 18. This allows the top of the forward portion of said rear fork 14 to act as a foot rest 22. A pad 24 is affixed to the foot rest 22. The pad 24 has a rough top surface which provides a secure place for a child to put his feet.

Referring now to FIG. 2, a sectional view of the running bike with foot rests of the instant invention taken along line 2-2 of FIG. 1 is shown. This view better shows the configuration of said rear fork 14 and its method of attachment to said frame member 12. Said rear fork 14 is made in two pieces with the forward end of each piece welded to said frame member 12. This view also shows that there is a foot rest 22 on either side of said rear fork 14 and each foot rest 22 includes a pad 24.

In operation, a child may sit on the seat portion of said seat and post 20 and apply forward force to the bike (chiefly through said handle bar 10) by “running.” Once the bike gets up to speed or when going down hill, the child can coast and place the feet on said pads 24 which are affixed to the forward portion of said rear fork 14. As may be seen, the horizontal configuration of said rear fork 14 and the configuration of said frame member 12 allow said seat tube 18 to be placed very near the ground. This allows for a very low seat height and means that the running bike with foot rests of the instant invention may be configured to allow for very small operators.

All elements of the running bike with foot rests are made of steel, but other materials having similar strength, weather resistance, and weight could be used. Said handle bar 10, said front fork 6, said front wheel 2, said rear wheel 4, and said seat and post 20 are conventional and may be obtained from a variety of sources.

While preferred embodiments of this invention have been shown and described above, it will be apparent to those skilled in the art that various modifications may be made in these embodiments without departing from the spirit of the present invention.

I claim:

1. A running bike with foot rests which resembles a conventional bicycle without pedals or other drive mechanism and includes a frame, a front fork and wheel, a rear fork and wheel, a steering mechanism to steer the front wheel, and a seat and post, in which the front wheel is considered forward and the rear wheel considered rearward comprising:
(1) a frame having a head tube at its forward end to accommodate the steering mechanism and the rear fork at its rearward end which is within 12.5 degrees of horizontal and protrudes rearward from the rearward end of the frame; said frame being angled downward and rearward from the head tube; and said frame having a hollow seat tube near its rearward end such that the seat and post may slide upward and downward through the seat tube and be secured at an appropriate height;
whereby a child may operate the running bike with foot rests as a push bike or running bike with a seat adjustable to a very low height and the forward portion of the rear fork capable of being used as a foot rest.

2. The running bike with foot rests of claim 1 in which a foot pad is affixed to the top surface of said rear fork near the forward end of said rear fork on either side of said frame.

3. A running bike with foot rests having the general configuration of a bicycle without pedals or other drive mechanism comprising:
(1) a frame having a forward end and a rearward end, the frame angling downward from the forward end to the rearward end, and the frame having a head tube affixed to its forward end;
(2) a front fork having a cylindrical upper portion and a lower portion being “U” shaped and opening downward, the cylindrical portion of said front fork being rotatably affixed within the head tube and the “U” shaped portion extending downward below said head tube;
(3) a front wheel with an axle being rotatably affixed to the bottom of the “U” shaped portion of said front fork;
(4) a handle bar being affixed to the cylindrical portion of said front fork;
(5) a rear fork having a “U” shape and opening rearward, the forward portion of the rear fork being affixed to the rearward portion of said frame and said rear fork being within 12.5 degrees of horizontal;
(6) a rear wheel with an axle being rotatably affixed to the rearward end of said rear fork,
(7) a hollow, cylindrical seat tube passing through and affixed to the rearward end of said frame forward of said rear fork;
(8) a seat and seat post slid ably affixed within the seat tube, the seat post being capable of sliding through said seat tube; and
(9) fastening means for removably fastening the seat and seat post at any position within said seat tube;
whereby a child may operate the running bike with foot rests as a push bike or running bike with a seat adjustable to a very low height and the forward portion of the rear fork capable of being used as a foot rest.

4. The running bike with foot rests of claim 2 in which a foot pad is affixed to the top surface of said rear fork near the forward end of said rear fork on either side of said frame.

5. A running bike with foot rests comprising:
(1) a frame having a forward end and a rearward end, the frame angling downward from the forward end to the rearward end, and the frame having a hollow, cylindrical head tube affixed to its forward end;
(2) a front fork having a cylindrical upper portion and a lower portion being “U” shaped and opening downward, the cylindrical portion of said front fork being rotatably affixed within the head tube and the “U” shaped portion extending downward below said head tube;
(3) a front wheel with an axle being rotatably affixed by the axle to the bottom of the “U” shaped portion of said front fork such that the front wheel is between the legs of the “U” shaped portion of said front fork;
(4) a handle bar being affixed to the top of the cylindrical portion of said front fork;
(5) a rear fork having a “U” shape and opening rearward, the forward portion of the rear fork being affixed to the rearward portion of said frame and said rear fork being within 12.5 degrees of horizontal;
(6) a rear wheel with an axle being rotatably affixed by the axle to the rearward end of said rear fork such that the rear wheel is between the legs of the “U” shaped portion of said rear fork;
(7) a hollow, cylindrical seat tube passing through and affixed to the rearward end of said frame forward of said rear fork;
(8) a seat and seat post slidably affixed within the seat tube, the seat post being capable of sliding through said seat tube; and
(9) fastening means for removably fastening the seat and seat post at any position within said seat tube;
whereby a child may operate the running bike with foot rests as a push bike or running bike with a seat adjustable to a very low height and the forward portion of the rear fork capable of being used as a foot rest.

6. The running bike with foot rests of claim 5 in which a foot pad is affixed to the top surface of said rear fork near the forward end of said rear fork on either side of said frame.
